(19) United States
(12) Patent Application Publication
(10) Pub. No.: US 2026/0091728 A1
(43) Pub. Date: Apr. 2, 2026

(54) VEHICLE LIGHT TRANSMISSION PANEL

(71) Applicant: TOYODA GOSEI CO., LTD., Kiyosu-shi (JP)

(72) Inventors: Masaki OKADA, Aichi (JP); Takayasu IDO, Aichi (JP); Kazuki TAKAO, Aichi (JP); Masaki SENDA, Aichi (JP); Yasuhisa KUMAMOTO, Aichi (JP); Koji OKUMURA, Aichi (JP); Yuhki KURAMITSU, Aichi (JP); Hiroko SHIBAKAWA, Aichi (JP); Keisuke HIGUCHI, Aichi (JP)

(21) Appl. No.: 19/325,056

(22) Filed: Sep. 10, 2025

(30) Foreign Application Priority Data
Sep. 27, 2024 (JP) 2024-169139

(51) Int. Cl. B60Q 1/50; B23K 26/40; B23K 26/57; G02B 1/111

(52) U.S. Cl. CPC B60Q 1/5035; G02B 1/111; B23K 26/40; B23K 26/57

(57) ABSTRACT

A vehicle light transmission panel to be disposed outward of a light source, constitute a part of a design surface of a vehicle, and transmit visible light emitted from the light source through a plurality of holes formed at the vehicle light transmission panel by laser processing, includes: a base material containing a resin having visible light transmittance; and a decorative layer disposed closer to the design surface than the base material, the plurality of holes penetrate the decorative layer in a thickness direction of the decorative layer, and between the base material and the decorative layer in the thickness direction, a protective layer, that has visible light transmittance and is configured to protect the base material from laser light, is provided.

### CROSS REFERENCE TO RELATED APPLICATION

This application is based on and claims priority under 35 USC 119 from Japanese Patent Application No. 2024-169139 filed on Sep. 27, 2024.

### TECHNICAL FIELD

The present invention relates to a vehicle light transmission panel.

### BACKGROUND ART

There has been conventionally proposed a vehicle light transmission panel including a decorative layer laminated on a surface of a base material having visible light transmittance, in which the decorative layer is formed with a plurality of holes that can transmit light from a light source disposed on a back surface side of the base material when the light is transmitted outward of the vehicle light transmission panel. An example of such a vehicle light transmission panel includes a display device described in Patent Literature 1. The display device includes a display as a light source, a smoke plate as a base material, and a screen as a decorative layer. The screen has a plurality of micropores that can transmit light emitted from the display.

Patent Literature 1: JP2001-331132A

### SUMMARY OF INVENTION

In such a vehicle transmission panel, it is conceivable to form a plurality of holes by laser processing. In this case, however, the following object occurs. That is, if removal of the decorative layer by laser light is not sufficient when forming the plurality of holes, light is blocked by the remaining decorative layer. Therefore, it is conceivable to form the plurality of holes such that a part of the holes reach the inside of the base material. In this case, however, a surface of the base material is roughened by the laser light, and fine unevenness is formed on the surface. As a result, the unevenness of the base material is visually recognized from the outside, which may impair an appearance of the vehicle light transmission panel.

Aspects of a vehicle light transmission panel for solving the above object will be described.

Aspect 1: A vehicle light transmission panel, which is to be disposed outward of a light source, constitute a part of a design surface of a vehicle, and transmit visible light emitted from the light source through a plurality of holes formed by laser processing, includes a base material made of a resin having visible light transmittance, and a decorative layer disposed closer to the design surface than the base material. The plurality of holes penetrate the decorative layer in a thickness direction. Between the base material and the decorative layer in the thickness direction, a protective layer that has visible light transmittance and protects the base material from laser light is provided.

According to the above configuration, when forming the plurality of holes by laser processing, a laminate in which the base material, the protective layer, and the decorative layer are laminated in this order is irradiated with laser light from the decorative layer. Accordingly, a portion of the decorative layer where the laser light is absorbed is removed first. On the other hand, since the base material is protected by the protective layer, the laser light is less likely to be absorbed by a surface of the base material. For this reason, fine unevenness on the surface of the base material because of being roughened by the laser light is prevented. Therefore, an appearance of the vehicle light transmission panel can be prevented from being impaired because of the unevenness being visually recognized from outside.

Aspect 2: In the vehicle light transmission panel according to Aspect 1, the protective layer includes a base resin having visible light transmittance and a filler that is dispersed in the base resin and reflects the laser light.

According to the above configuration, the laser light is less likely to be absorbed by the base resin since the laser light is reflected by the filler in the base resin. For this reason, the protective layer is less likely to be removed by the laser light, and a surface of the protective layer is less likely to be roughened by the laser light. Accordingly, the laser light is less likely to reach the surface of the base material. Therefore, the surface of the base material is prevented from being roughened by the laser light. That is, the base material is protected by the protective layer.

In this manner, according to the above configuration, the protective layer can be easily embodied by dispersing the filler that reflects the laser light in the base resin.

Aspect 3: In the vehicle light transmission panel according to Aspect 1, the protective layer includes a base resin having visible light transmittance and a filler that is dispersed in the base resin and absorbs the laser light, and the filler has higher heat resistance than the base material.

When the plurality of holes are formed by thermal processing using laser light, a portion of the protective layer where the laser light is absorbed is heated, and a periphery of the portion is heated by thermal conduction.

Here, according to the above configuration, the filler having higher heat resistance than the base material is dispersed in the base resin. For this reason, even when the laser light is absorbed by the base resin, efficiency of thermal conduction in the portion of the base resin where the laser light is absorbed is reduced by the filler. For this reason, the protective layer is less likely to be removed by the laser light, and a surface of the protective layer is less likely to be roughened by the laser light. Accordingly, the laser light is less likely to reach the surface of the base material. Therefore, the surface of the base material is prevented from being roughened by the laser light. That is, the base material is protected by the protective layer.

In this manner, according to the above configuration, the protective layer can be easily embodied by dispersing the filler having higher heat resistance than the base material in the base resin.

Aspect 4: In the vehicle light transmission panel according to any one of Aspects 1 to 3, the decorative layer includes a colored layer containing a colorant, and a concealing layer that is laminated on a surface of the colored layer on a side opposite to a design surface side thereof and contains a colorant having higher concealing power than the colorant contained in the colored layer.

According to the above configuration, visible light incident on the vehicle light transmission panel from outside is reflected by the colored layer, and thus the design surface of the vehicle light transmission panel is visually recognized from the outside in a color corresponding to the color of the colored layer.

Further, according to the above configuration, light transmitted through the colored layer out of the light incident on the vehicle light transmission panel from the outside is reflected or absorbed by the concealing layer. For this reason, a configuration such as the light source disposed inward of the vehicle light transmission panel is less likely to be visually recognized from the outside.

Therefore, the appearance of the vehicle light transmission panel when the light source is turned off can be improved.

Aspect 5: In the vehicle light transmission panel according to Aspect 4, the vehicle light transmission panel constitutes a part of a design surface of an outer shell of the vehicle, and the concealing layer has a Martens hardness of 30 N/mm² or less.

When the vehicle light transmission panel constitutes a part of the design surface of the outer shell of the vehicle, the vehicle light transmission panel is likely to be damaged by gravels or the like while the vehicle is traveling. When the damage to the vehicle light transmission panel reaches, for example, the concealing layer, the light from the light source leaks from the damaged portion of the vehicle light transmission panel when the light source is turned on, and thus the appearance of the vehicle light transmission panel may be impaired.

In this regard, according to the above configuration, the Martens hardness of the concealing layer is 30 N/mm² or less. For this reason, an impact applied on the vehicle light transmission panel by gravels or the like is alleviated by the concealing layer. Accordingly, the concealing layer is less likely to be damaged. As a result, leakage of the light from the damaged portion when the light source is turned on is prevented. Therefore, damage to the appearance of the vehicle light transmission panel by gravels or the like when the light source is turned on can be prevented.

Aspect 6: In the vehicle light transmission panel according to Aspect 4, the vehicle light transmission panel constitutes a part of a design surface of an outer shell of the vehicle, when the protective layer is a first protective layer, a second protective layer that protects the concealing layer is provided closer to the design surface than the concealing layer, and the second protective layer has a Martens hardness of 30 N/mm² or less.

When the vehicle light transmission panel constitutes a part of the design surface of the outer shell of the vehicle, the vehicle light transmission panel is likely to be damaged by gravels or the like while the vehicle is traveling. When the damage reaches, for example, the concealing layer, the light from the light source leaks from the damaged portion of the vehicle light transmission panel when the light source is turned on, and thus the appearance of the vehicle light transmission panel may be impaired.

In this regard, according to the above configuration, damage due to gravels or the like is less likely to reach the concealing layer by provision of the second protective layer.

In such a protective layer, as the Martens hardness is set to be smaller, an impact acting on the vehicle light transmission panel due to gravels or the like is more likely to be alleviated by the protective layer. In this regard, according to the above configuration, the Martens hardness of the second protective layer is 30 N/mm² or less. For this reason, an impact applied on the vehicle light transmission panel by gravels or the like is alleviated by the second protective layer. Accordingly, damage is less likely to occur in the second protective layer and thus the concealing layer. As a result, leakage of the light from the damaged portion when the light source is turned on is prevented. Therefore, damage to the appearance of the vehicle light transmission panel by gravels or the like when the light source is turned on can be prevented.

Aspect 7: In the vehicle light transmission panel according to Aspect 6, a filling layer that is filled in the plurality of holes and has visible light transmittance is provided on a side opposite to the base material with the decorative layer interposed in between in the thickness direction, and the filling layer is the second protective layer.

According to this configuration, damage to the vehicle light transmission panel due to gravels or the like is prevented from reaching the concealing layer due to the provision of the filling layer. Accordingly, damage to the appearance of the vehicle light transmission panel by gravels or the like when the light source is turned on can be further prevented.

According to the above configuration, the filling layer functions as the second protective layer. For this reason, a layer configuration of the vehicle light transmission panel can be reduced as compared with a case where the second protective layer is separately provided. Therefore, the layer configuration of the vehicle light transmission panel can be prevented from becoming complicated while preventing the appearance from being impaired.

According to the present invention, an appearance of a vehicle light transmission panel can be prevented from being impaired.

### BRIEF DESCRIPTION OF DRAWINGS

FIG. 1 is a front view showing a light emitting emblem as an embodiment of a vehicle light transmission panel;

FIG. 2 is an enlarged sectional view showing one of a plurality of holes of the light emitting emblem in FIG. 1;

FIG. 3 is photographs showing states of light leakage of test pieces in a light leakage test 1 in examples and comparative examples; and

FIG. 4 is photographs showing states of light leakage of test pieces in a light leakage test 2 in the examples and comparative examples.

### DESCRIPTION OF EMBODIMENTS

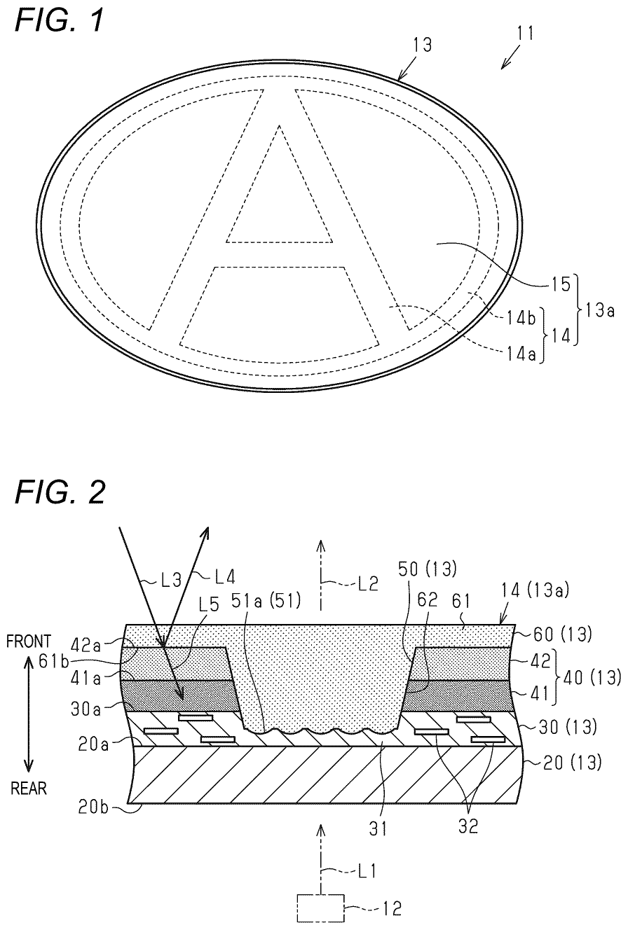

Hereinafter, an embodiment of a vehicle light transmission panel will be described with reference to FIGS. 1 and 2. In the present embodiment, the present invention is embodied as a light emitting emblem for a vehicle. Hereinafter, a front-rear direction of the vehicle will be simply referred to as the front-rear direction, and a forward direction and a rearward direction in the front-rear direction will be simply referred to as a forward and rearward.

As shown in FIGS. 1 and 2, a light source 12 and a light emitting emblem 13 disposed forward of the light source 12 are attached to a front portion 11 of a vehicle. The light source 12 is implemented by a light emitting element such as a light emitting diode (LED). The light source 12 is attached to the vehicle in a manner of emitting visible light forward. That is, in the present embodiment, the front-rear direction of the vehicle corresponds to an emission direction of the visible light from the light source 12. Hereinafter, the visible light emitted from the light source 12 may be simply referred to as light L1 to be distinguished from visible light emitted from outside.

The light emitting emblem 13 constitutes a part of an exterior panel that is an outer shell of the vehicle. The light emitting emblem 13 has a plate shape having a thickness in the front-rear direction when attached to the vehicle (see FIG. 2). The light emitting emblem 13 has a circular-shaped outer edge in a front view (see FIG. 1).

As shown in FIG. 1, a design surface 13a of the light emitting emblem 13 includes a display region 14 that displays a mark toward the outside of the vehicle and a background region 15 that is a background other than the display region 14. The “mark” here includes, for example, a designed character (logotype) indicating a vehicle manufacturer name, a vehicle name, a grade name, and the like, a figure (symbol mark) representing a vehicle manufacturer or the like, and a logo mark obtained by combining a character and a figure. In the present embodiment, the display region 14 includes a character portion 14a indicating an English letter “A” and an annular portion 14b extending along an outer peripheral edge of the light emitting emblem 13 and surrounding the character portion 14a.

As shown in FIG. 2, the light emitting emblem 13 includes a base material 20, a protective layer 30, a decorative layer 40, and a filling layer 60.

### Base Material 20

The base material 20 is formed of a transparent resin material having visible light transmittance. The resin material forming the base material 20 can use a transparent resin such as polypropylene (PP) and polycarbonate (PC). In the present embodiment, the base material 20 is formed of PP. The base material 20 is disposed on a side (rear side in the present embodiment) opposite to the design surface 13a of the light emitting emblem 13. Specifically, the base material 20 is disposed on a rearmost side of the light emitting emblem 13 and mainly constitutes a rear surface of the light emitting emblem 13. A rear surface 20b of the base material 20 faces the light source 12 in the front-rear direction.

### Protective Layer 30

As shown in FIG. 2, the protective layer 30 is a resin layer that protects the base material 20 from laser light, and is laminated on a front surface 20a of the base material 20. The “laser light” referred to here is laser light emitted from a known laser used for ablation processing such as a YAG laser and a carbon dioxide gas laser, and is, for example, light having a wavelength of 1064 nm (NIR laser), 532 nm (green laser), 355 nm (UV laser), or substantially 9.2 μm to 10.8 μm (FIR laser).

In the present embodiment, the base material 20 is provided with a primer layer (not shown) on the front surface 20a from a viewpoint of improving adhesion between the protective layer 30 and the base material 20. The protective layer 30 is a coating film formed by applying, onto the primer layer, a coating material including fillers 32 dispersed in a base resin 31 having visible light transmittance. The base resin 31 can use a known resin material contained in a synthetic resin coating material such as an acrylic resin, a urethane resin, an epoxy resin, a silicone resin, a polyester resin, and a melamine resin.

The fillers 32 can use, for example, fillers that reflect laser light. An example of the fillers that reflect laser light includes conductive fillers made of metal such as aluminum flakes. In the present embodiment, the fillers 32 are aluminum flakes (average particle diameter: 52 μm). A mass concentration of the fillers 32 in the protective layer 30 is, for example, 5% or more and 30% or less. The mass concentration of the fillers 32 in the protective layer 30 is preferably set such that transmittance of the light L1 in the protective layer 30 is not impaired. Specifically, the mass concentration is preferably 5% or more and 20% or less.

### Decorative Layer 40

As shown in FIG. 2, the decorative layer 40 decorates the light emitting emblem 13, and is disposed closer to the design surface 13a (in the present embodiment, forward) than the base material 20. The decorative layer 40 includes a concealing layer 41 and a colored layer 42 colored with a colorant such as a pigment and a dye.

The concealing layer 41 is a resin layer containing a colorant having higher concealing power than the colorant contained in the colored layer 42. Specifically, the concealing layer 41 is formed of a resin material in which a white pigment that reflects visible light such as titanium oxide or a black pigment that absorbs visible light such as carbon black is dispersed. In the present embodiment, the concealing layer 41 is a black coating film formed by applying a coating material in which carbon black is dispersed onto a front surface 30a of the protective layer 30. The concealing layer 41 has a Martens hardness of 30 N/mm² or less. From a viewpoint of improving chipping resistance, the Martens hardness of the concealing layer 41 is preferably 10 N/mm² or less, and more preferably 5 N/mm² or less. A measurement method of the Martens hardness is as described in examples to be described later.

The colored layer 42 is a resin layer containing a colorant. In the present embodiment, the colored layer 42 is a colored coating film formed by applying a coating material in which a pigment of any color is dispersed onto a front surface 41a of the concealing layer 41.

The light emitting emblem 13 has a plurality of holes 50 penetrating the decorative layer 40 in the front-rear direction, which is a thickness direction of the decorative layer 40. The display region 14 is defined by the plurality of holes 50. Each of the holes 50 penetrates the decorative layer 40, and a part thereof (hereinafter, bottom portion 51) extends to the protective layer 30. That is, the bottom portion 51 of the hole 50 is constituted by the protective layer 30. The bottom portion 51 has a bottom surface 51a constituting a part of the front surface 30a of the protective layer 30. The bottom surface 51a has an uneven shape formed by laser light.

### Filling Layer 60

As shown in FIG. 2, the filling layer 60 is provided on a side opposite to the base material 20 with the decorative layer 40 interposed in between in the front-rear direction. The filling layer 60 includes a base layer 61 and a plurality of filling portions 62. The base layer 61 is laminated and bonded to a front surface 42a of the colored layer 42. The filling portions 62 are parts of the filling layer 60 which are filled in the plurality of holes 50. The filling portions 62 protrude rearward from a rear surface 61b of the base layer 61.

The filling layer 60 is formed of a transparent resin material having visible light transmittance. An example of the resin material forming the filling layer 60 includes a transparent resin such as an acrylic resin. In the present embodiment, the filling layer 60 is formed of PMMA containing a colorant, and is colored and transparent. The colorant can use a freely selected colorant, and in the present embodiment, a pigment of a color (for example, yellow) having a complementary color relationship with a color (for example, blue) of the light L1 of the light source 12 is blended in the filling layer 60. Accordingly, a color of light L2 emitted forward from the light emitting emblem 13 can be an achromatic color (white) in which the color of the filling layer 60 and the color of the light L1 are mixed.

### Operations of Present Embodiment

When forming the plurality of holes 50 by laser processing, a laminate in which the base material 20, the protective layer 30, and the decorative layer 40 are laminated in this order is irradiated with laser light from the decorative layer 40. Accordingly, a portion of the decorative layer 40 where the laser light is absorbed is removed first. On the other hand, since the base material 20 is protected by the protective layer 30, the laser light is less likely to be absorbed by a surface (front surface 20a in the present embodiment) of the base material 20. For this reason, fine unevenness on the front surface 20a of the base material 20 because of being roughened by the laser light is prevented.

### Effects of Present Embodiment

(1) The light emitting emblem 13 is disposed forward of the light source 12, constitutes a part of a design surface of a vehicle, and transmits the light L1 emitted from the light source 12 through the plurality of holes 50 formed by laser processing. The light emitting emblem 13 includes the base material 20 made of a resin having visible light transmittance, and the decorative layer 40 disposed closer to the design surface 13a than the base material 20. The plurality of holes 50 penetrate the decorative layer 40 in the front-rear direction. Between the base material 20 and the decorative layer 40 in the front-rear direction, the protective layer 30 that has visible light transmittance and protects the base material 20 from laser light is provided.

According to such a configuration, the above-described operations are implemented. Therefore, an appearance of the light emitting emblem 13 can be prevented from being impaired because of the unevenness being visually recognized from outside.

(2) The protective layer 30 includes the base resin 31 and the fillers 32 that are dispersed in the base resin 31 and reflect laser light.

According to such a configuration, the laser light is less likely to be absorbed by the base resin 31 since the laser light is reflected by the fillers 32 in the base resin 31. For this reason, the protective layer 30 is less likely to be removed by the laser light, and a surface of the protective layer 30 is less likely to be roughened by the laser light. Accordingly, the laser light is less likely to reach the front surface 20a of the base material 20. Therefore, the front surface 20a of the base material 20 is prevented from being roughened by the laser light. That is, the base material 20 is protected by the protective layer 30.

In this manner, according to the above configuration, the protective layer 30 can be easily embodied by dispersing the fillers 32 that reflect the laser light in the base resin 31.

(3) The decorative layer 40 includes the colored layer 42 containing a colorant, and the concealing layer 41 that is laminated on a surface of the colored layer 42 on a side opposite to a surface (front surface 42a) thereof closer to the design surface 13a and contains a colorant having higher concealing power than the colorant contained in the colored layer 42.

According to such a configuration, visible light (light L3 in FIG. 2) incident on the light emitting emblem 13 from a front side is reflected by the colored layer 42 (light L4 in FIG. 2), and thus the design surface 13a of the light emitting emblem 13 is visually recognized from the front side in a color corresponding to the color of the colored layer 42.

Further, according to the above configuration, light L5 transmitted through the colored layer 42 out of the light L3 incident on the light emitting emblem 13 from the front side is absorbed by the concealing layer 41. For this reason, a configuration such as the light source 12 disposed rearward of the light emitting emblem 13 is less likely to be visually recognized from the front side.

Therefore, the appearance of the light emitting emblem 13 when the light source 12 is turned off can be improved.

(4) The light emitting emblem 13 constitutes a part of a design surface of an outer shell of the vehicle. The concealing layer 41 has a Martens hardness of 30 N/mm² or less.

When the light emitting emblem 13 constitutes a part of the design surface of the outer shell of the vehicle, the light emitting emblem 13 is likely to be damaged by gravels or the like when the vehicle is traveling. When the damage to the light emitting emblem 13 reaches, for example, the concealing layer 41, the light L1 from the light source 12 leaks from the damaged portion of the light emitting emblem 13 when the light source 12 is turned on, and thus the appearance of the light emitting emblem 13 may be impaired.

In this regard, according to the above configuration, the Martens hardness of the concealing layer 41 is 30 N/mm² or less. For this reason, an impact applied to the light emitting emblem 13 by gravels or the like is alleviated by the concealing layer 41. Accordingly, the concealing layer 41 is less likely to be damaged. As a result, leakage of the light L1 from the damaged portion when the light source 12 is turned on is prevented. Therefore, damage to the appearance of the light emitting emblem 13 by gravels or the like when the light source 12 is turned on can be prevented.

(5) The filling layer 60 that is filled in the plurality of holes 50 and has visible light transmittance is provided on a side opposite to the base material 20 with the decorative layer 40 interposed in between in the front-rear direction.

According to such a configuration, damage to the light emitting emblem 13 due to gravels or the like is prevented from reaching the concealing layer 41 due to the provision of the filling layer 60. Accordingly, it is possible to further prevent the appearance of the light emitting emblem 13 from being damaged by gravels or the like when the light source 12 is turned on.

### Modifications

The present embodiment can be modified and implemented as follows. The present embodiment and following modifications can be combined with each other and implemented without technical contradiction.

The light emitting emblem 13 is not limited to one in which the Martens hardness of the concealing layer 41 is 30 N/mm² or less as exemplified in the present embodiment, and the Martens hardness of the concealing layer 41 may be greater than 30 N/mm². In this case, for example, a second protective layer that has a Martens hardness of 30 N/mm² or less and protects the concealing layer 41 may be additionally provided forward of the concealing layer 41. The protective layer 30 at this time corresponds to a first protective layer described in the section “SUMMARY”.

According to such a configuration, damage due to gravels or the like is less likely to reach the concealing layer 41 by provision of the second protective layer.

In such a protective layer, as the Martens hardness is set to be smaller, an impact acting on the vehicle light transmission panel due to gravels or the like is more likely to be alleviated by the protective layer. In this regard, according to the above configuration, the Martens hardness of the second protective layer is 30 N/mm² or less. For this reason, an impact applied to the light emitting emblem 13 by gravels or the like is alleviated by the second protective layer. Accordingly, damage is less likely to occur in the second protective layer and thus the concealing layer 41. As a result, leakage of the light L1 from the damaged portion when the light source 12 is turned on is prevented. Therefore, damage to the appearance of the light emitting emblem 13 by gravels or the like when the light source 12 is turned on can be prevented.

The filling layer 60 may function as the second protective layer according to the modification. That is, the Martens hardness of the filling layer 60 may be set to be 30 N/mm² or less.

According to such a configuration, since the filling layer 60 functions as the second protective layer, a layer configuration of the light emitting emblem 13 can be reduced as compared with a case where the second protective layer is separately provided. Therefore, the layer configuration of the light emitting emblem 13 can be prevented from becoming complicated while preventing the appearance from being impaired.

The fillers according to the present invention are not limited to fillers that reflect laser light, such as the fillers 32 exemplified in the present embodiment. For example, the fillers may absorb laser light and have higher heat resistance than the resin material forming the base material 20. An example of such fillers includes glass flakes such as silica glass (heat-resistant temperature: 800° C.).

When the plurality of holes 50 are formed by thermal processing using laser light, a portion of the protective layer 30 where the laser light is absorbed is heated, and a periphery of the portion is heated by thermal conduction.

Here, according to the above configuration, fillers having higher heat resistance than the base material 20 are dispersed in the base resin 31. For this reason, even when the laser light is absorbed by the base resin 31, efficiency of thermal conduction in the portion of the base resin 31 where the laser light is absorbed is reduced by the fillers. For this reason, the protective layer 30 is less likely to be removed by the laser light, and the surface of the protective layer is less likely to be roughened by the laser light. Accordingly, the laser light is less likely to reach the surface (front surface 20a) of the base material 20. Therefore, the front surface 20a of the base material 20 is prevented from being roughened by the laser light. That is, the base material 20 is protected by the protective layer 30.

In this manner, according to the above configuration, the protective layer 30 can be easily embodied by dispersing the fillers 32 having higher heat resistance than the base material 20 in the base resin 31.

In the present embodiment, the light emitting emblem 13 has a configuration in which the protective layer 30 is laminated on a primer layer (not shown), and the protective layer 30 may be omitted and a primer layer in which the fillers 32 are dispersed may be disposed between the base material 20 and the concealing layer 41. In this case, the primer layer corresponds to a protective layer according to the present invention.

The light emitting emblem 13 is not limited to one that transmits the light L1 directly emitted from the light source 12 exemplified in the present embodiment. For example, the light emitting emblem 13 may transmit visible light indirectly emitted from the light source 12. In other words, the light source 12 may not be attached to the vehicle in a manner of emitting visible light forward. For example, the light source 12 may be attached in a manner of emitting visible light rearward, and may emit visible light along an upper-lower direction or the vehicle width direction. In this case, the visible light may be guided toward the light emitting emblem 13 using a separately disposed light guide or the like.

The light emitting emblem 13 is not limited to one disposed in the front portion 11 of the vehicle exemplified in the present embodiment. The light emitting emblem 13 may be disposed at a rear portion or a side portion of the vehicle as long as the light emitting emblem 13 is disposed outward of the light source. In a case of being disposed at the rear portion, outward of the light source corresponds to rearward in the front-rear direction, and in a case of being disposed at the side portion, outward of the light source corresponds to rightward or leftward in the vehicle width direction.

The vehicle light transmission panel according to the present invention is not limited to the light emitting emblem 13 constituting a part of an exterior panel as exemplified in the present embodiment, and can be embodied as the exterior panel itself.

### EXAMPLES

Hereinafter, the embodiment will be described more specifically with reference to examples and comparative examples.

### Preparation of Test Pieces

Test pieces of the examples and comparative examples were prepared as follows.

### Example 1

A flat plate (70 mm×150 mm×3 mm) made of PP was molded as a base material. A PP primer (product name: SFX3650) manufactured by Kansai Paint Co., Ltd. was applied to a surface of the molded base material at a dry film thickness (hereinafter, simply referred to as a film thickness) of 10 μm, and then a primer (product name: U-03) manufactured by Origin was applied at a film thickness of 10 μm, and dried at 80° C. for 30 minutes to be cured. Accordingly, a test piece in which a primer layer and a concealing layer were laminated in this order on the surface of the base material was obtained.

### Example 2

A test piece was obtained in the same manner as in Example 1 except that a primer (product name: U-03) manufactured by Origin was applied at a film thickness of 20 μm.

### Example 3

A test piece was obtained in the same manner as in Example 1 except that a primer (product name: U-03) manufactured by Origin was applied at a film thickness of 50 μm.

### Comparative Example 1

A PP primer (product name: SFX3650) manufactured by Kansai Paint Co., Ltd. was applied to a surface of a base material produced in the same manner as in Example 1 at a film thickness of 10 μm, and dried at 80° C. for 30 minutes. Accordingly, a test piece in which only a primer layer was laminated on the surface of the base material was obtained.

### Comparative Example 2

A test piece was obtained in the same manner as in Example 2 except that a primer (product name: R241) manufactured by Nippon Paint Co., Ltd. was used instead of the primer manufactured by Origin Co., Ltd.

### Comparative Example 3

A test piece was obtained in the same manner as in Example 3 except that a primer (product name: R241) manufactured by Nippon Paint Co., Ltd. was used instead of the primer manufactured by Origin Co., Ltd.

### Measurement Methods

### Film Thickness

A film thickness of each test piece of the examples and comparative examples was measured as follows.

A part of the test piece was carved using a carving knife, and a section having a vertical cross section was obtained using a scalpel. The section was observed with a microscope, and film thicknesses of a primer layer and a concealing layer were measured.

### Martens Hardness

For each test piece of the examples and comparative examples, an indentation depth and the Martens hardness were measured under following conditions in accordance with a measurement method for the Martens hardness in ISO 14577-1 “INSTRUMENTED INDENTATION HARDNESS AND MATERIAL PARAMETER FIRST PART: TEST METHOD”.

Measuring device: Microhardness tester (Fischer Scope HM2000 S) manufactured by Fischer Instruments K.K.
Indenter: Berkovich indenter (triangular pyramid)
Maximum test force: 300 mN
Test speed: 300 mN/20 sec

### Evaluation of Chipping Resistance

The test pieces of the examples and comparative examples were tested and evaluated as follows.

### Light Leakage Test 1

A gravelometer test was performed under following conditions in accordance with JASO M104 “TESTING METHOD FOR BRAKE TUBES” or SAE J400 “TEST FOR CHIP RESISTANCE OF SURFACE COATINGS”.

Apparatus: gravel test instrument (JA400LAZ) manufactured by Suga Test Instrument
Test temperature: −30° C.
Shot pressure: 0.4 MPa
Distance to test piece: 250 mm
Shot angle (attachment angle of test piece): 90 degrees
Shot material: No. 6 crushed stone specified in JIS A 5001 “CRUSHED STONE FOR ROAD CONSTRUCTION”
Weight of shot material: 300 g

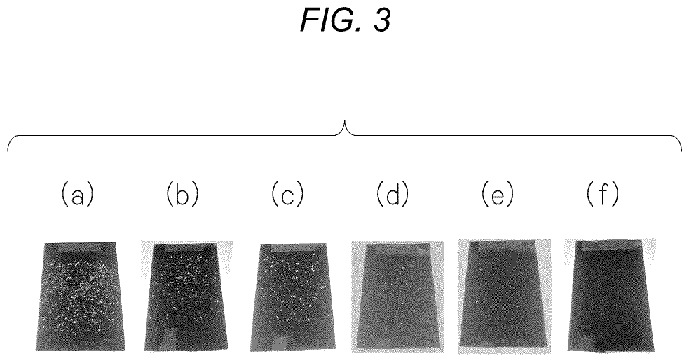

After the gravelometer test, each test piece from which coating film debris was removed was placed on a surface light emitting panel to observe presence and absence of light leakage (see (a) Comparative Example 1, (b) Comparative Example 2, (c) Comparative Example 3, (d) Example 1, (e) Example 2, and (f) Example 3 in FIG. 3). A degree of light leakage of each test piece was visually evaluated by comparing with a predetermined appearance standard. By observing a section cut out from each test piece with a microtome with a microscope, it is confirmed that a coating film was recessed and peeled from a base material at a damaged portion where light leaked in each test piece.

The chipping resistance of each test piece was evaluated based on the visual evaluation of light leakage. Evaluation criteria are as follows.

“1”: No or fairly little light leakage at damaged portion. This indicates that the chipping resistance is fairly high.

“2”: Partial light leakage at damaged portion. This indicates that the chipping resistance is high.

“3”: Extensive light leakage across damaged portion. This shows that the chipping resistance is not high, but is at a practically acceptable level.

“4”: Extensive light leakage across damaged portion with high proportion. This indicates that the chipping resistance is low and is at a practically lower limit level.

“5”: Extensive light leakage across damaged portion with fairly high proportion. This indicates that the chipping resistance is fairly low and is not practical.

An evaluation result of the chipping resistance evaluation for each test piece is shown in Table 1 together with the measured film thickness, indentation depth, and Martens hardness.

TABLE 1

| | Film Thickness (μm) | | | | Martens | Evaluation of |
|---|---|---|---|---|---|---|
| | Primer | Concealing | | Indentation | Hardness | Chipping |
| | Layer | Layer | Total | Depth (μm) | (N/mm²) | Resistance |
| Comparative | 9.3 | — | 9.3 | 18 | 40 | 5 |
| Example 1 | | | | | | |
| Comparative | 9.1 | 33.0 | 42.1 | 16 | 100 | 4 |
| Example 2 | | | | | | |
| Comparative | 9.1 | 45.9 | 55.0 | 14 | 100 | 4 |
| Example 3 | | | | | | |
| Example 1 | 9.8 | 21.2 | 31.0 | 23 | 3 | 3 |
| Example 2 | 12.0 | 23.9 | 35.9 | 29 | 3 | 2 |
| Example 3 | 13.7 | 65.8 | 79.5 | 33 | 3 | 1 |

### Light Leakage Test 2

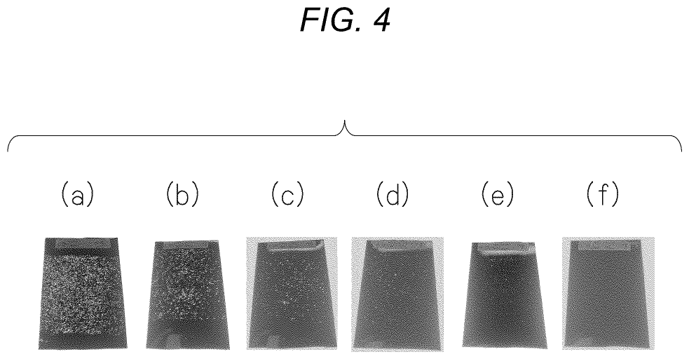

The test and evaluation were performed under the same conditions as in the light leakage test 1 except that No. 7 crushed stone specified in JIS A 5001 “CRUSHED STONE FOR ROAD CONSTRUCTION” was used as a shot material (see (a) Comparative Example 1, (b) Comparative Example 2, (c) Comparative Example 3, (d) Example 1, (e) Example 2, and (f) Example 3 in FIG. 4). The chipping resistance of each test piece was evaluated based on visual evaluation of light leakage. An evaluation result of the chipping resistance evaluation for each test piece is shown in Table 2 together with the measured film thickness.

TABLE 2

| | Film Thickness (μm) | | | Evaluation |
|---|---|---|---|---|
| | Primer | Concealing | | of Chipping |
| | Layer | Layer | Total | Resistance |
| Comparative Example 1 | 13.4 | — | 13.4 | 5 |
| Comparative Example 2 | 10.5 | 29.3 | 39.8 | 5 |
| Comparative Example 3 | 14.3 | 54.1 | 68.4 | 4 |
| Example 1 | 10.6 | 23.6 | 34.2 | 4 |
| Example 2 | 12.7 | 29.8 | 42.5 | 2 |
| Example 3 | 14.6 | 65.0 | 79.6 | 1 |

### Results

As shown in Table 1, in the test pieces subjected to Test 1, all of Examples 1 to 3 showed higher chipping resistance evaluation than Comparative Examples 1 to 3.

As shown in Table 2, in the test pieces subjected to Test 2, Examples 2 and 3 showed higher chipping resistance evaluation than Comparative Examples 1 to 3, while Example 1 showed the same evaluation as Comparative Example 3. This is considered to be because No. 7 crushed stone had a smaller weight than No. 6 crushed stone, and thus the number of shot materials in Test 2 was larger than that in Test 1.

As shown in Tables 1 and 2, in all of Examples 1 to 3, the chipping resistance evaluation was higher as a film thickness of a concealing layer became larger.

From these results, it was confirmed that excellent chipping resistance was obtained by setting the Martens hardness of a surface of the concealing layer measured at a test speed of 300 mN/20 sec to be 30 N/mm² or less. It was further confirmed that more excellent chipping resistance was obtained by setting the Martens hardness to be 30 N/mm² or less and increasing the film thickness.

### REFERENCE SIGNS LIST

L1, L2, L3, L4, L5: light
11: front portion
12: light source
13: light emitting emblem
13a: design surface
14: display region
14a: character portion
14b: annular portion
15: background region
20: base material
20a: front surface
20b: rear surface
30: protective layer
30a: front surface
31: base resin
32: filler
40: decorative layer
41: concealing layer
41a: front surface
42: colored layer
42a: front surface
50: hole
51: bottom portion
51a: bottom surface
60: filling layer
61: base layer
61b: rear surface
62: filling portion

What is claimed is:

1. A vehicle light transmission panel to be disposed outward of a light source, constitute a part of a design surface of a vehicle, and transmit visible light emitted from the light source through a plurality of holes formed at the vehicle light transmission panel by laser processing, the vehicle light transmission panel comprising:
a base material comprising a resin having visible light transmittance; and
a decorative layer disposed closer to the design surface than the base material, wherein
the plurality of holes penetrate the decorative layer in a thickness direction of the decorative layer, and
between the base material and the decorative layer in the thickness direction, a protective layer, that has visible light transmittance and is configured to protect the base material from laser light, is provided.

2. The vehicle light transmission panel according to claim 1, wherein
the protective layer comprises a base resin having visible light transmittance and a filler that is dispersed in the base resin and is configured to reflect the laser light.

3. The vehicle light transmission panel according to claim 1, wherein
the protective layer comprises a base resin having visible light transmittance and a filler that is dispersed in the base resin and is configured to absorb the laser light, and
the filler has higher heat resistance than the base material.

4. The vehicle light transmission panel according to any one of claim 1, wherein
the decorative layer comprises a colored layer containing a colorant, and a concealing layer that is laminated on a surface of the colored layer on a side opposite to the design surface and contains a colorant having higher concealing power than the colorant contained in the colored layer.

5. The vehicle light transmission panel according to any one of claim 2, wherein
the decorative layer comprises a colored layer containing a colorant, and a concealing layer that is laminated on a surface of the colored layer on a side opposite to the design surface and contains a colorant having higher concealing power than the colorant contained in the colored layer.

6. The vehicle light transmission panel according to any one of claim 3, wherein
the decorative layer comprises a colored layer containing a colorant, and a concealing layer that is laminated on a surface of the colored layer on a side opposite to the design surface and contains a colorant having higher concealing power than the colorant contained in the colored layer.

7. The vehicle light transmission panel according to claim 4, wherein
the vehicle light transmission panel constitutes a part of a design surface of an outer shell of the vehicle, and
the concealing layer has a Martens hardness of 30 N/mm² or less.

8. The vehicle light transmission panel according to claim 5, wherein
the vehicle light transmission panel constitutes a part of a design surface of an outer shell of the vehicle, and
the concealing layer has a Martens hardness of 30 N/mm² or less.

9. The vehicle light transmission panel according to claim 6, wherein
the vehicle light transmission panel constitutes a part of a design surface of an outer shell of the vehicle, and
the concealing layer has a Martens hardness of 30 N/mm² or less.

10. The vehicle light transmission panel according to claim 4, wherein
the vehicle light transmission panel constitutes a part of a design surface of an outer shell of the vehicle,
the vehicle light transmission panel further comprises a second protective layer that is configured to protect the concealing layer and is provided closer to the design surface than the concealing layer, and
the second protective layer has a Martens hardness of 30 N/mm² or less.

11. The vehicle light transmission panel according to claim 5, wherein
the vehicle light transmission panel constitutes a part of a design surface of an outer shell of the vehicle,
the vehicle light transmission panel further comprises a second protective layer that is configured to protect the concealing layer and is provided closer to the design surface than the concealing layer, and
the second protective layer has a Martens hardness of 30 N/mm² or less.

12. The vehicle light transmission panel according to claim 6, wherein
the vehicle light transmission panel constitutes a part of a design surface of an outer shell of the vehicle,
the vehicle light transmission panel further comprises a second protective layer that is configured to protect the concealing layer and is provided closer to the design surface than the concealing layer, and
the second protective layer has a Martens hardness of 30 N/mm² or less.

13. The vehicle light transmission panel according to claim 10, wherein
the second protective layer is a filling layer that is filled in the plurality of holes, has visible light transmittance and is provided on a side opposite to the base material with the decorative layer interposed in between in the thickness direction, and
the filling layer is the second protective layer.

14. The vehicle light transmission panel according to claim 11, wherein
the second protective layer is a filling layer that is filled in the plurality of holes, has visible light transmittance and is provided on a side opposite to the base material with the decorative layer interposed in between in the thickness direction, and
the filling layer is the second protective layer.

15. The vehicle light transmission panel according to claim 12, wherein
the second protective layer is a filling layer that is filled in the plurality of holes, has visible light transmittance and is provided on a side opposite to the base material with the decorative layer interposed in between in the thickness direction, and
the filling layer is the second protective layer.
